(19) United States
(12) Patent Application Publication
(10) Pub. No.: US 2009/0203341 A1
(43) Pub. Date: Aug. 13, 2009

(54) Wireless receiver and wireless communication system having the same

(75) Inventor: Hyun-Won Mun, Yongin-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/322,910

(22) Filed: Feb. 9, 2009

(30) Foreign Application Priority Data
Feb. 13, 2008 (KR) 10-2008-0012989

(51) Int. Cl. H04B 7/00

(52) U.S. Cl. 455/255; 455/230; 370/277

(57) ABSTRACT

A wireless receiver includes a feedback path, and a main path. The feedback path feeds back a first signal at a predetermined frequency range to remove a desired signal at the predetermined frequency range, and the feedback path to outputs an accumulated blocker error signal. The predetermined frequency range is lower than a radio frequency (RF) range. The main path subtracts the accumulated blocker error signal from a second signal including a blocker signal at the RF range to generate a third signal and down-converts the third signal to output the first signal at the predetermined frequency range.

### BACKGROUND

1. Technical Field

Example embodiments relate to a wireless communication system, and, more particularly, to a wireless receiver and a wireless communication system having the same.

2. Description of the Related Art

Wireless transceivers are widely used in wireless communication systems. A wireless transceiver generally includes a wireless receiver for receiving and demodulating signals and a wireless transmitter for transmitting the signals.

Wireless receivers often times receive a desired signal and a blocker signal, that is, an undesired signal. Conventional wireless systems have generally used surface acoustic wave (SAW) filters to remove the blocker signal from received signals at a radio-frequency range, so that the desired signal can be discerned.

### SUMMARY

Example embodiments provide a wireless receiver including a circuit removing a blocker signal and a wireless communication system having the wireless receiver.

Example embodiments provide a method of removing a blocker signal in a wireless receiver.

In some example embodiments, a wireless receiver includes a feedback path, and a main path.

The feedback path feeds back a first signal at a predetermined frequency range to remove a desired signal at the predetermined frequency range and to output an accumulated blocker error signal. The predetermined frequency range is lower than a radio frequency (RF) range. The main path subtracts the accumulated blocker error signal from a second signal including a blocker signal at the RF range to generate a third signal and to down-convert the third signal so that the first signal at the predetermined frequency range is output. For example, the blocker signal may correspond to a transmission leakage signal.

In some embodiments, the wireless receiver can further include a low noise amplifier which receives an input signal and amplifies the input signal to generate a second signal.

In some embodiments, the predetermined frequency range can correspond to a baseband frequency range. The main path may include a subtracter and a first mixer. The subtracter subtracts the accumulated blocker error signal from the second signal to generate a third signal. The first mixer down-converts the third signal by a first local oscillation signal. The feedback path can include a second mixer, an integrator, and a third mixer. The second mixer mixes the first signal by a second oscillation signal so that frequencies of a blocker signal and the desired signal included in the first signal are exchanged. The integrator accumulates an output signal of the second mixer. The output signal of the second mixer can correspond to a blocker error signal, that is, the blocker signal included-in the first signal so that the integrator can accumulate blocker error signals during a recursive feedback loop to generate an accumulated blocker error signal at a baseband frequency range. The third mixer up-converts an output signal of the integrator by the second local oscillation signal to output an accumulated blocker error signal at the RF range.

In some embodiments, the first local oscillation signal can correspond to a receiver local oscillation signal and the second local oscillation signal may correspond to a transmitter local oscillation signal. The second mixer can be configured to mix the first signal by a signal of a frequency that is obtained by subtracting a frequency of the second local oscillation signal from a frequency of the first local oscillation signal.

In some embodiments, the predetermined frequency range may correspond to an intermediate frequency (IF) range. The wireless receiver may further include a first signal processing unit and a second signal processing unit. The first signal processing unit performs a signal processing operation on the first signal at the IF range. The second signal processing unit down-converts an output signal of the first signal processing unit.

In some example embodiments of the present invention, a wireless communication system includes a duplexer, a wireless transceiver, a power amplifier, and a baseband processor. The duplexer selects one of a transmission mode and a reception mode of an antenna. The wireless transceiver includes a main path operating in an RF range and a feedback path operating in a lower frequency range relative to the main path. The wireless transceiver receives and transmits a signal at the RF range. The power amplifier amplifies an output signal of the wireless transceiver and provides the amplified signal to the duplexer. The baseband processor is coupled to the wireless transceiver. The baseband processor performs a signal processing operation at a baseband frequency range and controls the wireless communication system.

In some embodiments, the baseband processor may perform a signal processing operation on an output signal of the wireless transceiver and provides the processed signal to a peripheral circuit, or receives data from the peripheral circuit to provide the received data to the wireless transceiver. For example, the peripheral circuit may include a microphone, a speaker, a display, or a keypad.

In some embodiments, the feedback path is configured to feedback a first signal at a predetermined frequency range in order to remove a desired signal included in a first signal and to output an accumulated blocker error signal. The predetermined frequency range is lower than the RF range.

The main path may subtract the accumulated blocker error signal from a second signal including a blocker signal at the RF range in order to generate a third signal and to down-convert the third signal so that the first signal at the predetermined frequency range is output. The blocker signal may correspond to a transmission leakage signal.

For example, the predetermined frequency range may correspond to a baseband frequency range or an intermediate frequency range.

Consequently, the wireless receiver according to the example embodiment may include a built-in circuit for removing the blocker signal on a chip. The wireless receiver feeds back and mixes the signal a frequency of which is lower than the RF range such as the baseband frequency range so that the wireless receiver may effectively remove the blocker signal so as to be unaffected by parasitic elements. The resulting wireless communication system can be implemented with a wireless receiver having a relatively small size.

### BRIEF DESCRIPTION OF THE DRAWINGS

FIG. 1 is a block diagram illustrating a wireless communication system according to an example embodiment.

FIG 2 is a block diagram illustrating a wireless receiver according to an example embodiment of the present invention.

FIG. 3 a block diagram illustrating a wireless receiver according to an example embodiment of the present invention.

FIG. 4 is a simulation diagram illustrating a transmission leakage signal rejection ratio of the wireless receiver of FIG. 3.

FIG. 5 is a block diagram illustrating a wireless receiver according to an example embodiment of the present invention.

FIG. 6 is a block diagram illustrating a wireless receiver according to an example embodiment of the present invention.

FIG. 7 is a block diagram illustrating a wireless receiver according to an example embodiment of the present invention.

### DESCRIPTION OF EMBODIMENTS

This application claims priority under 35 USC § 119 to Korean Patent Application No. 10-2008-0012989, filed on Feb. 13, 2008 in the Korean Intellectual Property Office (KIPO), the disclosure of which is incorporated herein in its entirety by reference.

Embodiments of the present invention now will be described more fully with reference to the accompanying drawings, in which embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

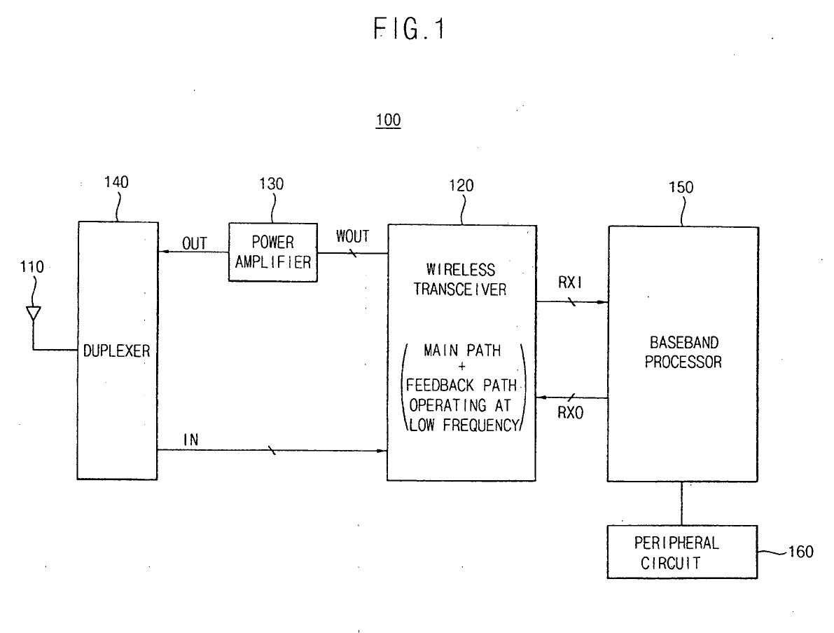

FIG. 1 is a block diagram illustrating a wireless communication system according to an example embodiment.

Referring to FIG. 1, a wireless communication system 100 may include an antenna 110, a wireless transceiver 120, a power amplifier 130, a duplexer 140, and a baseband processor 150. The antenna 110 receives and transmits signals at a radio frequency (RF) range. The duplexer 140 selects one of a reception mode or a transmission mode of operation of the antenna 110. The wireless transceiver 120 can include a main path operating at the RF range and a feedback path operating at a predetermined frequency range which is lower than the RF range. The wireless transceiver 120 receives and transmits signals at the RF range.

The power amplifier 130 amplifies an output signal WOUT output by the wireless transceiver 120 and provides the amplified output signal OUT to the duplexer 140. The baseband processor 150 coupled to the wireless transceiver 120 performs a signal processing at a baseband range and controls the wireless communication system 100. The wireless transceiver 120 receives an input signal IN at the RF range from the duplexer 140 and performs the signal processing. Thereafter, the wireless transceiver 120 generates a signal RXI at the predetermined range which is lower than the RF range and provides the signal RXI to the baseband processor 150. The wireless transceiver 120 processes a signal RXO at the RF range output by the baseband processor 150 and provides the processed signal WOUT to the power amplifier 130.

The wireless communication system 100 can further include a peripheral circuit 160. The peripheral circuit 160 may include data input circuits and data output circuits. For example, the data input circuits can comprise a keypad, a microphone, a camera, and on the like. The data output circuits can comprise a display panel, a speaker, a printer, and the like. The peripheral circuit 160 may further include memory devices for storing data.

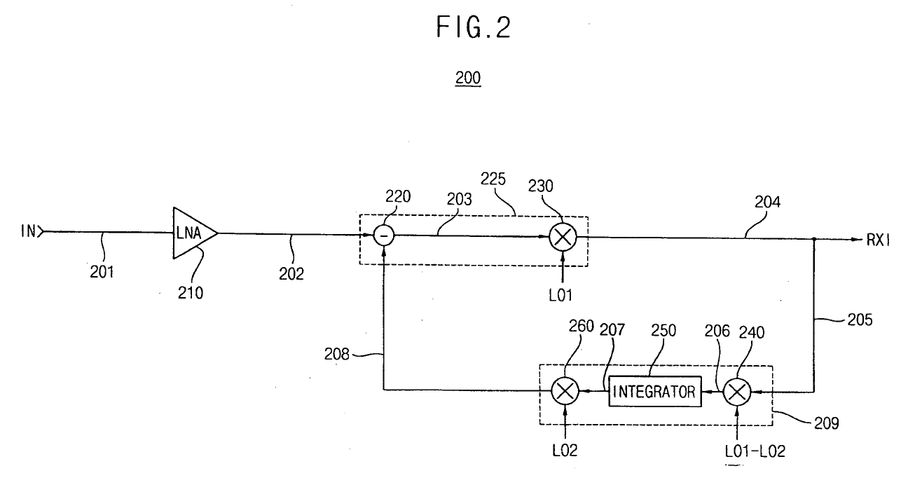

FIG. 2 is a block diagram illustrating a wireless receiver according to an example embodiment of the present invention. A wireless receiver 200 may be included in the wireless transceiver 120 in the wireless communication system 100 of FIG. 1.

Referring to FIG. 2, the wireless receiver 200 can include a feedback path 209 and a main path 225. The wireless receiver 200 can further include a low noise amplifier (LNA) 210 which receives and amplifies an input signal IN to generate a second signal on a line 202.

The feedback path 209 can include a second mixer 240, an integrator 250, and a third mixer 260. The feedback path 209 feeds back a first signal RXI at a baseband frequency range which is lower than the RF range in order to remove a desired signal included in the first signal RXI so that an accumulated blocker error signal at the RF range is output. The accumulated blocker error signal corresponds to an accumulated value of the blocker signals included in the first signal RXI during a recursive feedback loop. Due to phase differences and non-idealities of the circuit, the blocker signal included in the first signal RXI is not the same as the blocker signal included in a second signal on the line 202. Due to a recursive nature of a feedback loop, the accumulated blocker error signal may correspond to the blocker signal included in the second signal following the operation of the recursive integration operation of the repeated feedback loop even though the blocker signals and the blocker error signals are continuous in time.

A second mixer 240 mixes an output signal of the first mixer 230 with a first local oscillation signal LO1 and a second local oscillation signal LO2. For example, the second mixer 240 can mix the output signal of the first mixer 230 with a signal obtained by subtracting the second local oscillation signal LO2 from the first local oscillation signal LO1. Frequency components of a blocker error signal and the desired signal included in the output signal of the first mixer 230 may be exchanged by the second mixer 240. Passing through an integrator 250, the desired signal included in the output signal on a line 206 can be removed and the blocker error signals may be accumulated or integrated in the integrator 250 so that the blocker signal may be reconstructed. That is, an accumulated blocker error signal output from the feedback path 209 may be substantially same as the blocker signal included in the second signal on the line 202. A third mixer 260 up-converts the output signal of the integrator 250 by the second local oscillation signal LO2 and outputs the accumulated blocker error signal at the RF range. In one embodiment, the integrator 250 can be implemented by a low-pass filter (LPF).

The subtracter 220 subtracts the output signal of the feedback path 209 from the second signal on the line 202. The output signal of the feedback path 209 present on line 208 corresponds to the reconstructed blocker signal, that is, the accumulated blocker error signal. As mentioned above, the accumulated blocker error signal can converge toward the blocker signal after passing through the recursive feedback loop. The first mixer 230 down-converts the output signal of the subtracter 220 by the first local oscillation signal LO1.

Passing through the feedback path 209, the output signal of the wireless receiver 200, that is, the first signal RXI exclusively includes a desired signal at the baseband frequency range. Because the accumulated blocker error signal on line 208 is removed from the second signal on line 202 by the subtracter 220, the first signal RXI on line 204 no longer includes the blocker signal after repeated feedback loop operations.

The wireless receiver 200 mixes and outputs the blocker signal at the baseband frequency range which is lower than the RF range so that the blocker signal included in the input signal IN may be effectively removed despite the presence of certain non-idealities in the circuits. Moreover, because the signals at the baseband frequency range pass through the feedback loop, the feedback path does not affect the signals passing through the main path and the feedback path is unaffected by parasitic elements. When the wireless receiver is implemented as a multi-band unit, the feedback path does not need to be implemented in each band for eliminating the parasitic elements. As a result the wireless receiver can be implemented as a compact, space-efficient, unit.

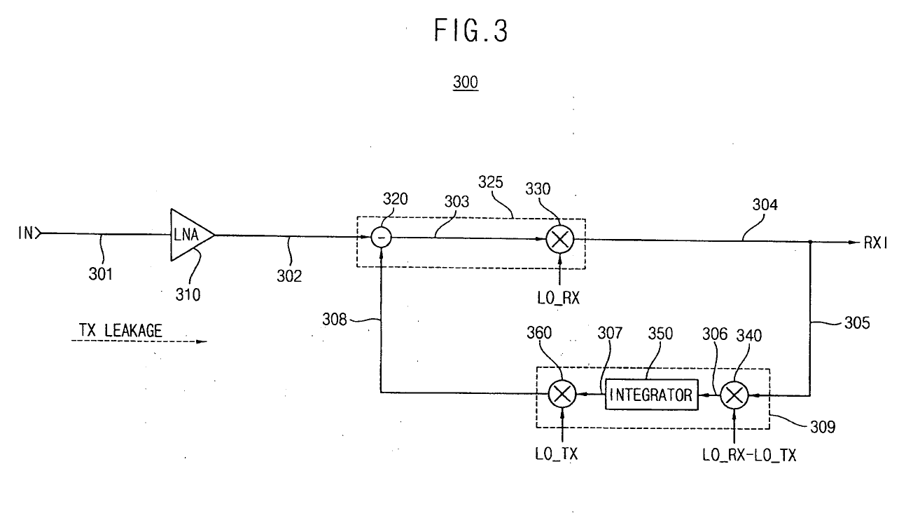

FIG. 3 a block diagram illustrating a wireless receiver according to an example embodiment of the present invention. In a wireless receiver 300 of FIG. 3, a transmission leakage signal TX LEAKAGE corresponds to the blocker signal. The wireless receiver 300 can be included in the wireless transceiver 120 of FIG. 1.

In the wireless receiver 300 of FIG. 3, a receiver local oscillation signal LO_RX substitutes for the first local oscillation signal LO1 and a transmitter local oscillation signal LO_TX substitutes for the second local oscillation signal LO2, in comparison to the wireless receiver 200 of FIG. 2.

The wireless receiver 300 can further include a feedback path 309 and a main path 325, and can further include a low-noise amplifier LNA 310.

The main path 325 may include a subtracter 320 and a first mixer 330. The first mixer 330 down-converts a third signal on a line 303 by the receiver local oscillation signal LO_RX.

The feedback path 309 can include a second mixer 340, an integrator 350, and a third mixer 360. In the feedback path 309, the second mixer 340 mixes a first signal RXI present on line 305 by the receiver local oscillation signal LO_RX and the transmitter local oscillation signal LO_TX, a frequency of which is lower than a frequency of the receiver local oscillation signal LO_RX. For example, the second mixer 340 can mix the first signal RXI by a signal obtained by subtracting the transmitter local oscillation signal LO_TX from the receiver local oscillation signal LO_RX. The second mixer 340 exchanges frequency components of a blocker signal and a desired signal included in the first signal RXI. The blocker signal included in the first signal RXI may be referred as a blocker error signal. An integrator 350 accumulates the blocker error signals through the repeated feedback loop. In one embodiment, the integrator 350 may be implemented by a low-pass filter LPF. The third mixer 360 up-converts an output signal of the integrator 350 by the transmitter local oscillation signal LO_TX and outputs the accumulated blocker error signal at the RF range.

Because an output signal of the feedback path 309 may correspond to the reconstructed blocker signal at the RF range after passing through the recursive feedback loop, the main path 325 subtracts the accumulated blocker error signal from an output signal of the LNA 310 and down-converts the third signal so that the first signal RXI on line 304 is output. The first signal RXI can include a portion of the blocker signal. Due to the recursive nature of the feedback loop, the accumulated blocker error signal on line 308 can converge toward the blocker signal included in the second signal on line 302 so that they cancel at subtractor 320. In this manner, the wireless receiver can compensate for non-idealities such as a non-zero phase and a non-unity gain around the feedback loop, as compared to a feed-forward loop.

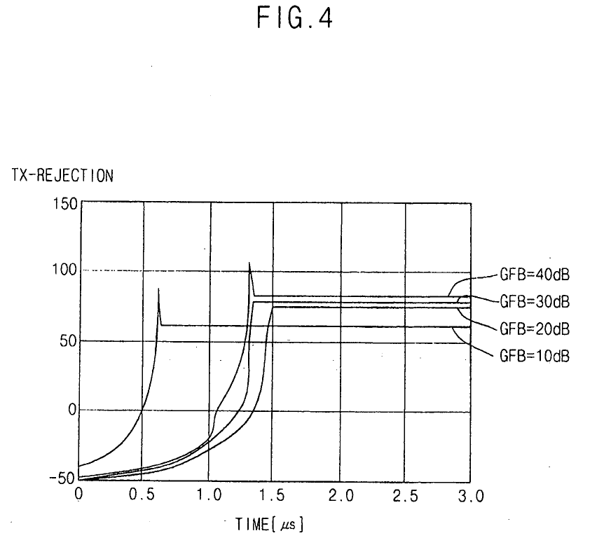

FIG. 4 is a simulation diagram illustrating a transmission leakage signal rejection ratio of the wireless receiver of FIG. 3. GFB denotes a gain of the feedback path and TX-REJECTION denotes the transmission leakage signal rejection ratio.

Referring to FIG. 4, the transmission leakage signal rejection ratio varies minimally between 50 and 100 as the gain of the feedback loop increases from 10 dB to 40 dB. However the conventional wireless receiver has a great variation in according to the gain of the feedback loop. Accordingly, a wireless receiver according to embodiments of the present invention can have an improved transmission leakage signal rejection ratio, as compared to the conventional wireless receiver.

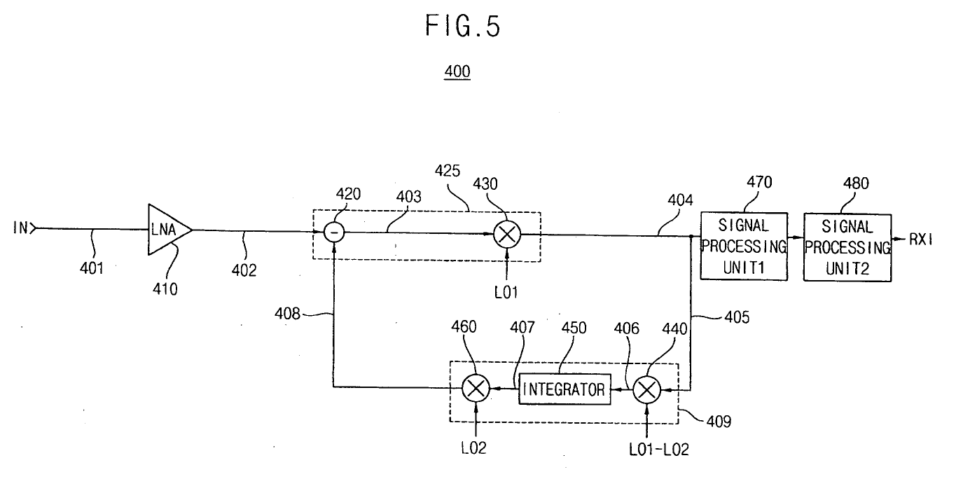

FIG. 5 is a block diagram illustrating a wireless receiver according to an example embodiment of the present invention. A wireless receiver 400 may be included in the wireless transceiver 120 in FIG. 1.

In a manner similar to the wireless receiver 200 of FIG. 2 described above, a first mixer 430 included in a main path 425 down-converts a third signal on a line 403 to generate a signal at an intermediate frequency (IF) range. Moreover, the wireless receiver 400 of the present embodiment may further include a first signal processing unit 470 and a second signal processing unit 480. The first signal processing unit 470 processes an output signal of a first mixer 430 at the IF range. The second signal processing unit 480 down-converts an output signal of the first signal processing unit 470 to generate a first signal RXI.

As described above, a feedback path 409 can include a second mixer 440, an integrator 450, and a third mixer 460. The feedback path 409 feeds back a signal on a line 404 at the IF range so that a desired signal included in the signal on the line 404 is removed. Consequently, an accumulated blocker error signal at the RF range is output. An operation of the feedback path 409 is similar to the operation of the feedback path 209 included in the wireless receiver in FIG. 2. The second mixer 440 mixes the output signal of the signal on the line 404 so that frequencies of a blocker signal and a desired signal included in the output signal of the main path 425 are exchanged. The integrator 450 accumulates blocker error signals at the IF range corresponding to the blocker signals included in the signals on the line 404 during the recursive feedback loop. The third mixer 460 up-converts an output signal of the integrator 450 so that the accumulated blocker error signal at the RF range is output.

The subtractor 420 subtracts the accumulated blocker error signal from the second signal on a line 402. The first mixer 430 down-converts an output signal of the subtracter 420 by the first local oscillation signal LO1 so that the signal on the line 404 at the IF range on a line 404 includes only a minimal or negligible portion of the blocker signal.

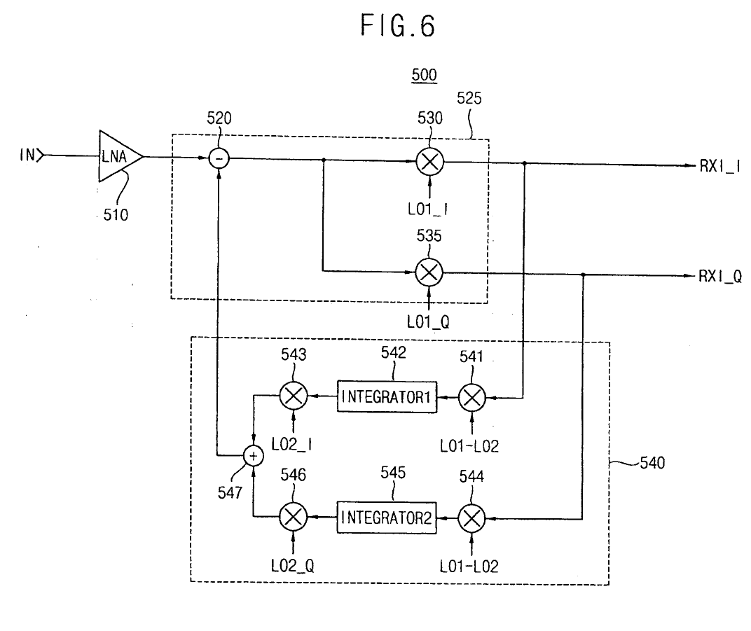

FIG 6 is a block diagram illustrating a wireless receiver according to an example embodiment of the present invention. A wireless receiver 500 of FIG. 6 generates signals RXI_I and RXI_Q which are orthogonal with each other. The wireless receiver 500 may be included in the wireless transceiver 120 in FIG. 1.

Referring to FIG. 6, the wireless receiver 500 may include a feedback path 540 and a main path 525. The wireless receiver 500 may further include a low-noise amplifier LNA 510 which amplifies a low-noise element included in a received input signal IN and provides the amplified signal to the subtracter 520.

The feedback path 540 feeds back the in-phase -reception signal RXI_I and the quadrature-phase reception signal RXI_Q at the baseband frequency range which is lower than the RF range. The feedback path 540 removes desired signals included in the in-phase reception signal RXI_I and the quadrature-phase reception signal RXI_Q and outputs an accumulated blocker error signal at the RF range. The feedback path 540 may include a third mixer 541, a first integrator 542, a fourth mixer 543, a fifth mixer 544, a second integrator 545, and a sixth mixer 546. The third mixer 541 mixes the in-phase reception signal RXI_I with the first local oscillation signal LO1 and the second local oscillation signal LO2 so that frequencies of a blocker signal and the desired signal included in the in-phase reception signal RXI_I are exchanged. A frequency of the second local oscillation signal LO2 can be lower than a frequency of the first local oscillation signal LO1. For example, the third mixer 541 mixes the in-phase reception signal RXI_I by a signal a frequency of which is obtained by subtracting a frequency of the second local oscillation signal LO2 from a frequency of the first local oscillation signal LO1. The first integrator 542 accumulates the blocker error signal corresponding to the blocker signal included in the in-phase reception signal RXI_I. Therefore, a first accumulated blocker error signal at the RF range is output after up-converting through the fourth mixer 543 using a second in-phase local oscillation signal LO2_I.

The fifth mixer 544 mixes the quadrature-phase reception signal RXI_Q with the first local oscillation signal LO1 and the second local oscillation signal LO2 in order to exchange frequencies of a blocker signal and the desired signal included in the quadrature-phase reception signal RXI_Q. For example, the fifth mixer 544 mixes the quadrature-phase reception signal RXI_Q with the signal obtained by subtracting the frequency of the second local oscillation signal LO2 from the frequency of the first local oscillation signal LO1.

The second integrator 545 accumulates output signals of the fifth mixer 544 during the recursive feedback loop. The sixth mixer 546 up-converts the accumulated blocker error signal corresponding to an output signal of the second integrator 545 by a second quadrature-phase local oscillation signal LO2_Q and outputs a second accumulated blocker error signal at the RF range. In certain embodiments, the first and second integrators 542 and 545 can be implemented using low-pass filters LPF.

The adder 547 sums the first and second accumulated blocker error signals and provides the added signal to the subtracter 520. The output signal of the feedback path 540 may approach to the blocker signal included in the output signal of the LNA 5 1 0 after the recursive feedback loop.

The main path 525 can include a subtracter 520, a first mixer 530, and a second mixer 535. The main path 525 subtracts the output signal of the feedback path 540 corresponding to an added value of accumulated blocker error signals from an output signal of the LNA 5 1 0 at the RF range and down-converts the subtracted signal so that the in-phase reception signal RXI_I and the quadrature-phase reception signal RXI_Q at the baseband frequency range are generated.

The subtracter 520 subtracts the output signal of the feedback path 540 from the output signal of the LNA 510. The first mixer 530 down-converts an output signal of the subtracter 520 by a first in-phase local oscillation signal LO1_I. The second mixer 535 down-converts an output signal of the subtracter 520 by a first quadrature-phase local oscillation signal LO1_Q.

After recursive feedback loop, the added signal may correspond to the blocker signal included in the output signal of the LNA 510 so that the in-phase reception signal RXI_I and the quadrature-phase reception signal RXI_Q include only a minimal or negligible portion of the blocker signals.

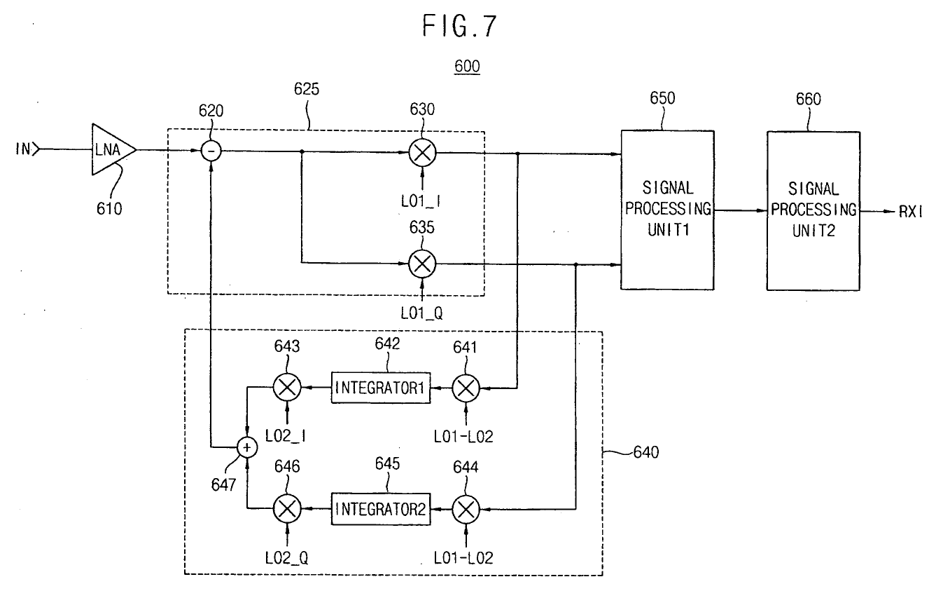

FIG. 7 is a block diagram illustrating a wireless receiver according to an example embodiment of the present invention. A wireless receiver 600 may be included in the wireless transceiver 120 in FIG. 1.

In the wireless receiver 600 of FIG. 7, a main path 625 may include a subtracter 620, a first mixer 630, and a second mixer 635. The first mixer 630 down-converts an output signal of the subtracter 620 by the first in-phase local oscillation signal LO1_I in order to generate signals at the intermediate frequency (IF) range. A second mixer 635 down-converts the output signal of the subtracter 620 by the first quadrature-phase local oscillation signal LO1_Q. The converted signals are orthogonal with each other. The wireless receiver 600 can further include a first signal processing unit 650 and a second signal processing unit 660. The first signal processing unit 650 processes the output signals of first and second mixers 630 and 635 at the IF range. The second signal processing unit 660 down-converts an output signal of the first signal processing unit 650 and generates a first signal RXI.

A feedback path 640 feeds back the output signals of the first and second mixers 630 and 635 at the IF range which is lower than the RF range in order to remove desired signals included in the output signals of the first and second mixers 630 and 635. Consequently, a totally accumulated blocker error signal at the RF range is generated.

The feedback path 640 may include a third mixer 641, a first integrator 642, a fourth mixer 632, a fifth mixer 644, a second integrator 645, and a sixth mixer 646. The operation of the feedback path 640 is similar to the feedback path 540 in FIG. 6.

Referring to FIGS. 1 to 7, a method of removing a blocker signal of the wireless receiver according to the present invention can include the following steps.

1) feeding back a first signal at a predetermined frequency range which is lower than a RF range.

2) outputting an accumulated blocker error signal by removing a desired signal from the first signal.

3) generating a third signal by subtracting the accumulated blocker error signal from a second signal at the RF frequency range.

4) generating the first signal at the predetermined frequency range by down-converting the third signal.

As mentioned above, the receiver and the communication system according to the present invention mixes signals at a frequency range that is lower than the RF range so that the receiver and the communication system of the present invention may effectively remove or mitigate the effect of any blocker signals received in the received signal.

While embodiments of the invention have been particularly shown and described with references to preferred embodiments thereof, it will be understood by those skilled in the art that various changes in form and details may be made herein without departing from the spirit and scope of the invention as defined by the appended claims.

What is claimed is:

1. A wireless receiver, comprising:
a feedback path configured to feedback a first signal at a predetermined frequency range to remove a desired signal at the predetermined frequency range and to output an accumulated blocker error signal, the predetermined frequency range being lower than a radio frequency range;
a main path configured to subtract the accumulated blocker error signal from a second signal including a blocker signal at the radio frequency range to generate a third signal, and to down-convert the third signal so that the first signal at the predetermined frequency range is output.

2. The wireless receiver of claim 1, further comprising:
a low noise amplifier configured to receive an input signal and to amplify the input signal to generate the second signal.

3. The wireless receiver of claim 1, wherein the blocker signal corresponds to a transmission leakage signal.

4. The wireless receiver of claim 1, wherein the predetermined frequency range corresponds to a baseband frequency range.

5. The wireless receiver of claim 4, wherein the main path comprises:
a subtracter configured to subtract the accumulated blocker error signal from the second signal to generate a third signal;
a first mixer configured to down-convert the third signal by a first local oscillation signal.

6. The wireless receiver of claim 5, wherein the feedback path comprises:
a second mixer configured to mix the first signal by a second oscillation signal so that frequencies of the blocker signal and the desired signal included in the first signal are exchanged;
an integrator configured to accumulate an output signal of the second mixer; and
a third mixer configured to up-convert an output signal of the integrator by the second local oscillation signal to output the accumulated blocker error signal at the radio frequency range.

7. The wireless receiver of claim 6, wherein the first local oscillation signal corresponds to a receiver local oscillation signal and the second local oscillation signal corresponds to a transmitter local oscillation signal.

8. The wireless receiver of claim 6, wherein the second mixer is configured to mix the first signal by a signal having a frequency corresponding to a frequency of the second local oscillation signal subtracted from a frequency of the first local oscillation signal.

9. The wireless receiver of claim 1, wherein the predetermined frequency range corresponds to an intermediate frequency range.

10. The wireless receiver of claim 9, further comprising:
a first signal processing circuit configured to perform a signal processing operation on the first signal at the intermediate frequency range;
a second signal processing unit configured to down-convert an output signal of the first signal processing circuit.

11. A wireless communication system, comprising:
a duplexer configured to select one of a transmission mode and a reception mode of an antenna;
a wireless transceiver including a main path operating in a radio frequency range and a feedback path operating in a lower frequency range relative to the main path, the wireless transceiver being configured to receive and transmit signals at the radio frequency range;
a power amplifier configured to amplify an output signal from the wireless transceiver and to provide the amplified signal to the duplexer;
a baseband processor coupled to the wireless transceiver, the baseband processor performing a signal processing operation at a baseband frequency range and controlling the wireless communication system.

12. The wireless communication system of claim 11, wherein the baseband processor is configured to perform a signal processing operation on an output signal of the wireless transceiver and to provide the processed signal to a peripheral circuit, and to receive data from the peripheral circuit to provide the received data to the wireless transceiver.

13. The wireless communication system of claim 11, wherein the peripheral circuit comprises at least one of a microphone, a speaker, a display, and a keypad.

14. The wireless communication system of claim 11, wherein the feedback path is configured to feedback a first signal at a predetermined frequency range to remove a desired signal included in a first signal, and to output an accumulated blocker error signal, the predetermined frequency range being lower than the radio frequency range.

15. The wireless communication system of claim 14, wherein the main path is configured to subtract the accumulated blocker error signal from a second signal including a blocker signal at the radio frequency range to generate a third signal, and to down-convert the third signal so that the first signal at the predetermined frequency range is output.

16. The wireless communication system of claim 14, wherein the blocker signal corresponds to a transmission leakage signal.

17. The wireless communication system of claim 14, wherein the predetermined frequency range corresponds to a baseband frequency range.

18. The wireless communication system of claim 14, wherein the predetermined frequency range corresponds to an intermediate frequency range.
